(19) United States
(12) Patent Application Publication
(10) Pub. No.: US 2019/0346560 A1
(43) Pub. Date: Nov. 14, 2019

(54) RADAR SYSTEM FOR TRAILER VEHICLE

(71) Applicant: CUB ELECPARTS INC., FUXING TOWNSHIP (TW)

(72) Inventors: San-Chuan Yu, FUXING TOWNSHIP (TW); Cheng-Hsin Li, FUXING TOWNSHIP (TW); Wei-Chang Liang, FUXING TOWNSHIP (TW)

(21) Appl. No.: 16/010,810

(22) Filed: Jun. 18, 2018

(30) Foreign Application Priority Data
May 8, 2018 (TW) 107205987

(51) Int. Cl. G01S 13/93; G01S 13/04

(52) U.S. Cl. CPC G01S 13/931; G01S 2013/9378; G01S 2013/9332; G01S 13/04

(57) ABSTRACT

A radar system installed in a trailer vehicle including a master vehicle having a main connector disposed at a rear side thereof and a slave vehicle having a sub connector disposed at a front side thereof and pivotally connectable to the main connector is disclosed to include a host unit mounted in the master vehicle and a radar mounted at the slave vehicle and electrically connected to the host unit after connection between the main connector and the sub connector. Thus, this arrangement achieves the proposed efficacy and purpose of the present invention to facilitate electrical connection and disconnection between the host unit and the radar, allowing the driver to learn the information of the warning signal generated by the radar.

### BACKGROUND OF THE INVENTION

### 1. Field of the Invention

The present invention relates to vehicle radar technology and more particularly, to a radar system for used in a trailer vehicle.

### 2. Description of the Related Art

With the recent booming camping habits, the demand for trailers for camping has also gradually increased. The original RVs, sedans or SUVs are provided with a trailer to constitute camping trailers for camping. However, due to the large volume of the body of the camping trailer, when the driver of the RV, the sedan or the SUV wants to make a turn or to reverse the vehicle during driving, the body of the trailer often blocks the driver's line of sight. In the long run, it is inconvenient for the driver.

Therefore, it is desirable to provide a trailer vehicle radar system that effectively solves the aforesaid problems.

### SUMMARY OF THE INVENTION

The present invention has been accomplished under the circumstances in view. It is the main object of the present invention to provide a radar system practical for use in a trailer vehicle, which facilitates electrical connection and disconnection between the host unit and the radars and has a warning effect to help the driver in making judgment.

To achieve this and other objects of the present invention, a radar system is installed in a trailer vehicle. The trailer vehicle comprises a master vehicle and a slave vehicle. The master vehicle comprises a main connector mounted at a rear side thereof. The slave vehicle comprises a sub connector mounted at a front side thereof to face toward the main connector of the master vehicle and pivotally connectable to the main connector of the master vehicle. The radar system comprises an electrical socket mounted at the master vehicle, an electrical plug mounted at the slave vehicle, a host unit and a radar.

The host unit is mounted in the master vehicle, comprising an electrical wire electrically connected to the main connector of the master vehicle or the electrical socket.

The radar is mounted at the slave vehicle, comprising an electrical wire that is electrically connected to the sub connector of the slave vehicle or the electrical plug for conduction with the electrical wire of the host unit through the main connector of the master vehicle or the electrical socket.

Preferably, the radar protrudes over the rear side of the slave vehicle or is mounted at the junction between the rear side of the slave vehicle and one lateral long side of the slave vehicle to incline toward the rear side of the slave vehicle.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a schematic top view of a trailer vehicle radar system in accordance with a first embodiment of the present invention.

FIG. 2 is a schematic top view illustrating an operation status of the trailer vehicle radar system in accordance with the first embodiment of the present invention.

FIG. 3 is a schematic top view of a trailer vehicle radar system in accordance with a second embodiment of the present invention.

### DETAILED DESCRIPTION OF THE INVENTION

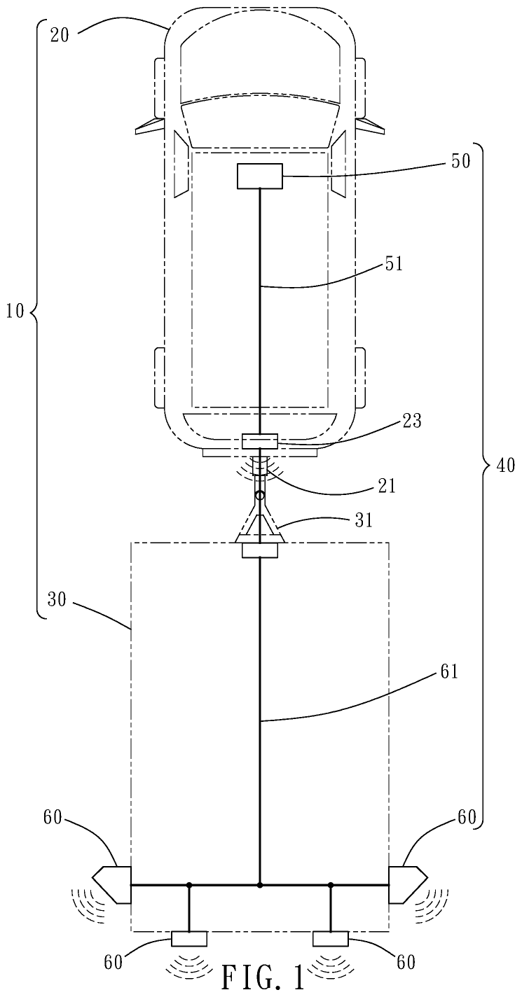

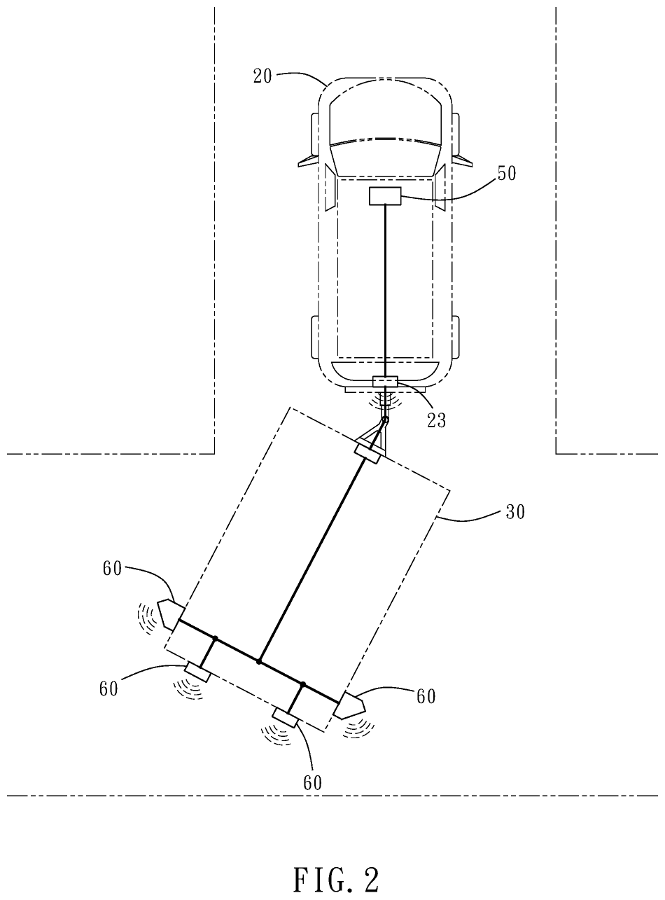

Referring to FIGS. 1 and 2, a trailer vehicle radar system in accordance with a first embodiment of the present invention is shown. As illustrated, the radar system 40 is installed in a trailer vehicle 10. The trailer vehicle 10 comprises a master vehicle 20 and a slave vehicle 30. The radar system 40 comprises a host unit 50 and four radars 60.

The master vehicle 20 comprises a main connector 21 and a reversing radar 23 respectively mounted at a rear side thereof. It is worth mentioning that the master vehicle 20 can be a RV (Recreation Vehicle), sedan or SUV (Sport Utility Vehicle). The main connector 21 can be a main component of a latching device, magnetic fastener or hook fastener consisting of a metal, semiconductor or superconductor having a conductive function. The reversing radar 23 detects the direction of travel and will alarm if there is an object approaching the rear of the master vehicle 20.

The slave vehicle 30 comprises a sub connector 31 mounted at a front side thereof to face toward the main connector 21 of the master vehicle 20 and is electrically and pivotally connectable to the main connector 21 of the master vehicle 20. It is worth mentioning that the slave vehicle 30 can be a trailer for camping trailer, truck trailer or large joint vehicle. Further, the sub connector 31 of the slave vehicle 30 is a sub-component of the latching device, magnetic fastener or hook fastener consisting of a metal, semiconductor or superconductor having a conductive function.

The host unit 50 is mounted in the master vehicle 20 comprising an electrical wire 51 electrically connected with the main connector 21 of the master vehicle 20.

The radars 60 are respectively protrudingly mounted at a rear side and two opposite lateral long sides of the body of the slave vehicle 30. The two of radars 60 that are respectively protrudingly mounted at the two opposite lateral long sides of the body of the slave vehicle 30 form an inclination angle with the respective lateral long side of the body of the slave vehicle 30. Preferably, the other two of radars 60 at the two opposite lateral long sides of the body of the slave vehicle 30 both or individually incline toward the rear side of the body of the slave vehicle 30. Each radar 60 comprises an electrical wire 61 electrically connected to the sub connector 31 of the slave vehicle 30 so that the main connector 21 of the master vehicle 20 can be electrically coupled to the electrical wire 51 of the host unit 50.

According to the radar system 40 disclosed in the first preferred embodiment of the present invention, which is suitable for installation in the trailer vehicle 10, the desired effect is:

1. It has means that facilitates electrical connection and disconnection. Referring to FIG. 1 again, when wishing to connect the master vehicle 20 of the trailer vehicle 10 and the slave vehicle 30 in series, pivotally connect the sub connector 31 of the slave vehicle 30 to the main connector 21 of the master vehicle 20, at this time, the electrical wire 51 of the host unit 50 of the master vehicle 20 is electrically connected to the sub connector 31 of the main connector 21 to achieve electrical connection with the electrical wires 61 of the radars 60 at the slave vehicle 30. Further, when wishing to disconnect the slave vehicle 30 from the master vehicle 20, disconnect the sub connector 31 of the slave vehicle 30 from the main connector 21 of the master vehicle 20. In other words, it achieves the proposed efficacy and purpose of the present invention to facilitate electrical connection and disconnection between the host unit 50 and the radars 60.

2. It provides individual warnings to facilitate driver's judgment. Referring to FIG. 2 again, as described above, when the driver connects the host unit 50 with the radars 60 at the slave vehicle 30, the host unit 50 provides a radar activation signal through the electrical wires 51,61 to the radars 60 at the slave vehicle 30 to activate the radars 60; when the driver drives, turns or reverses the master vehicle 20, the driver can learn the information of warning signals generated by the radars 60 at the slave vehicle 30 through the alert unit (such as buzzer or warning light) of the host unit 50. Thus, the accident caused by driver due to driving dead angles will be greatly reduced.

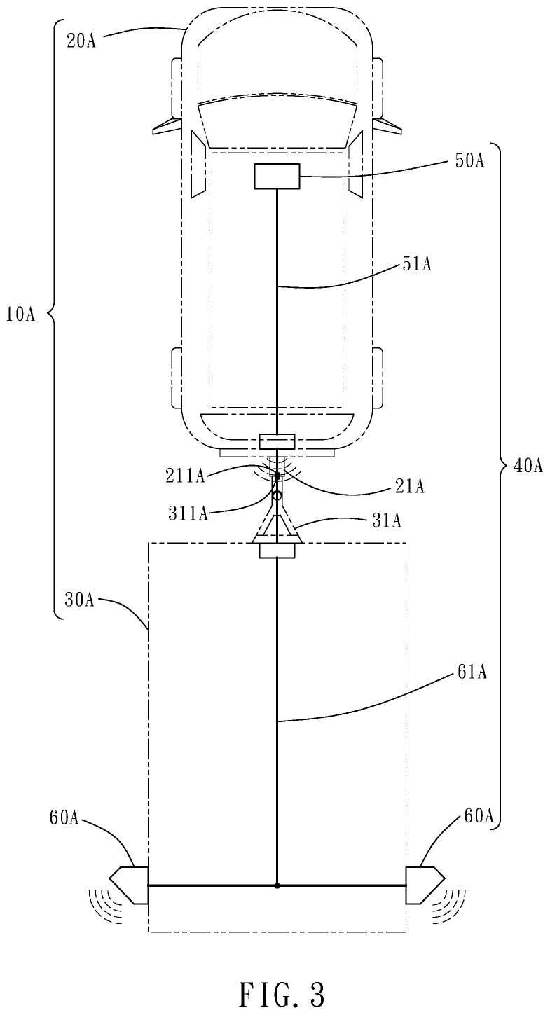

FIG. 3 illustrates a radar system 40A installed in a trailer vehicle 10A in accordance with a second embodiment of the present invention. This second embodiment is substantially similar to the aforesaid first embodiment. Similarly, the trailer vehicle 10A comprises a master vehicle 20A and a slave vehicle 30A. The master vehicle 20A comprises a main connector 21A mounted at a rear side thereof. The slave vehicle 30A comprises a sub connector 31A mounted at a front side thereof to face toward the main connector 21A of the master vehicle 20A and pivotally connectable to the main connector 21A of the master vehicle 20A. The exceptions are outlined hereinafter:

The radar system 40A provides only two radars 60A that are respectively mounted at the two opposite lateral long sides of the slave vehicle 30A near its rear side. Preferably, these two radars 60A are inclined at the same time or in different directions toward the rear side of the slave vehicle 30A. It is worth mentioning that in an alternate form of this second embodiment, the radar system 40A simply provides one single radar 60A that is mounted at one lateral long side of the slave vehicle 30A near its rear side.

The radar system 40A further comprises an electrical socket 211A and a mating electrical plug 311A. The electrical socket 211A is mounted in the main connector 21A of the master vehicle 20A and electrically connected to the electrical wire 51A of the host unit 50A. The electrical plug 311A is mounted at the sub connector 31A of the slave vehicle 30A to face toward the electrical socket 211A in the main connector 21A of the master vehicle 20A and electrically connected to the of the electrical wires 61A of the radars 60A.

When wishing to connect the master vehicle 20A of the trailer vehicle 10A and the slave vehicle 30A in series, pivotally connect the sub connector 31A of the slave vehicle 30A to the main connector 21A of the master vehicle 20A, and then connect the electrical plug 311A at the sub connector 31A of the main connector 21A to electrical socket 211A in the main connector 21A of the master vehicle 20. At this time, the host unit 50 in the master vehicle 20 is electrically connected with the electrical wires 61A of the radars 60A via the electrical wire 51, the electrical plug 311A and the electrical socket 211A.

What is claimed is:

1. A radar system installed in a trailer vehicle comprising a master vehicle and a slave vehicle, said master vehicle comprising a main connector mounted at a rear side thereof, said slave vehicle comprising a sub connector mounted at a front side thereof to face toward said main connector of said master vehicle and pivotally connector to said main connector of said master vehicle, the radar system comprising:
a host unit mounted in said master vehicle, said host unit comprising an electrical wire electrically connected to said main connector of said master vehicle; and
at least one radar mounted on said slave vehicle, each said radar comprising an electrical wire electrically connected to said main connector of said master vehicle;
wherein said host unit provides a radar activation signal through the electrical wire thereof to each said radar to activate each said radar when said at least one radar is electrically connected to said host unit.

2. The radar system as claimed in claim 1, wherein each said radar protrudes over the rear side of said slave vehicle.

3. The radar system as claimed in claim 1, wherein each said radar protrudes over the junction between one respective lateral long side of said slave vehicle and the rear side of said slave vehicle.

4. The radar system as claimed in claim 3, wherein said radar is inclined toward the rear side of said slave vehicle, forming an inclination angle with each of two opposite lateral long sides of said slave vehicle.

5. The radar system as claimed in claim 1, wherein the number of said at least one radar is plural, and the multiple said radars respectively protrude over the rear side of said slave vehicle.

6. The radar system as claimed in claim 1, wherein the number of said at least one radar is plural, and the multiple said radars respectively protrude over the junctions between the rear side of said slave vehicle and the two opposite lateral long sides of said slave vehicle.

7. The radar system as claimed in claim 7, wherein the number of said at least one radar is plural, and the multiple said radars respectively incline toward the rear side of said slave vehicle, forming an inclination angle with each of the two opposite lateral long sides of said slave vehicle.

8. A radar system installed in a trailer vehicle comprising a master vehicle and a slave vehicle, said master vehicle comprising a main connector mounted at a rear side thereof, said slave vehicle comprising a sub connector mounted at a front side thereof to face toward said main connector of said master vehicle and pivotally connector to said main connector of said master vehicle, the radar system comprising:
an electrical socket mounted in said main connector of said master vehicle;
an electrical plug mounted at said sub connector of said slave vehicle and electrically connectable to said electrical socket;
a host unit mounted in said master vehicle, said host unit comprising an electrical wire electrically connected to said electrical socket; and
at least one radar mounted at said slave vehicle, each said radar comprising an electrical wire electrically connected to said electrical plug for conduction with the electrical wire of said host unit electrically;
wherein when said host unit is switched to an alert mode, said host unit transmits a radar activation signal through the electrical wire of said host unit, said electrical socket, said electrical plug and the electrical wire of each said radar to each said radar to activate each said radar.

9. The radar system as claimed in claim 8, wherein each said radar protrudes over the rear side of said slave vehicle.

10. The radar system as claimed in claim 8, wherein each said radar protrudes over the junction between one respective lateral long side of said slave vehicle and the rear side of said slave vehicle.

11. The radar system as claimed in claim 10, wherein said radar is inclined toward the rear side of said slave vehicle, forming an inclination angle with each of two opposite lateral long sides of said slave vehicle.

12. The radar system as claimed in claim 8, wherein the number of said at least one radar is plural, and the multiple said radars respectively protrude over the rear side of said slave vehicle.

13. The radar system as claimed in claim 8, wherein the number of said at least one radar is plural, and the multiple said radars respectively protrude over the junctions between the rear side of said slave vehicle and the two opposite lateral long sides of said slave vehicle.

14. The radar system as claimed in claim 13, wherein the number of said at least one radar is plural, and the multiple said radars respectively incline toward the rear side of said slave vehicle, forming an inclination angle with each of the two opposite lateral long sides of said slave vehicle.
